(19) United States
(12) Patent Application Publication
(10) Pub. No.: US 2026/0291546 A1
(43) Pub. Date: Sep. 24, 2026

(54) METHOD AND APPARATUS FOR DOPPLER SHIFT COMPENSATION IN COMMUNICATION SYSTEM

(71) Applicant: ELECTRONICS AND TELECOMMUNICATIONS RESEARCH INSTITUTE, Daejeon (KR)

(72) Inventors: Jae Sheung SHIN, Daejeon (KR); Sung Min OH, Daejeon (KR)

(73) Assignee: ELECTRONICS AND TELECOMMUNICATIONS RESEARCH INSTITUTE, Daejeon (KR)

(21) Appl. No.: 19/473,759

(22) PCT Filed: Apr. 15, 2024
(86) PCT No.: PCT/KR2024/005026

§ 371 Date: Oct. 8, 2025

(30) Foreign Application Priority Data
Jun. 22, 2023 (KR) 10-2023-0080544

(51) Int. Cl. H04B 7/01; H04W 64/00

(52) U.S. Cl. CPC H04B 7/01; H04W 64/003

(57) ABSTRACT

This first communication node operation method for accessing a TN and an NTN may comprise the steps of: receiving, from a first TN cell, first linkage information including information about one or more NTN cells including at least the first NTN cell in a first TN cell area overlapping a first NTN cell area; checking location information of a first satellite for forming the first NTN cell included in the first linkage information; receiving, from the first NTN cell, a first signal to which DS pre-compensation based on the location of a first reference point of the first NTN cell is applied; and applying, with respect to the received first signal, additional DS compensation based on location information of a first satellite, location information of the first reference point, and location information of the first communication node.

### TECHNICAL FIELD

The present disclosure relates to a technique for Doppler shift (DS) compensation in a communication system, and more particularly, to a technique for effectively compensating for a DS according to a Doppler effect occurring due to a relative speed between communication entities.

### BACKGROUND ART

Communication networks (e.g. 5G communication networks, 6G communication networks, etc.) are being developed to provide improved communication services than existing communication networks (e.g. long term evolution (LTE), LTE-Advanced (LTE-A), etc.). The 5G communication network (e.g. new radio (NR) communication network) can support frequency bands above 6 GHz as well as frequency bands below 6 GHz. That is, the 5G communication network can support frequency range 1 (FR1) bands and/or FR2 bands. The 5G communication network can support various communication services and scenarios compared to the LTE communication network. For example, the usage scenarios of the 5G communication network may include enhanced Mobile BroadBand (eMBB), Ultra Reliable Low Latency Communication (URLLC), massive Machine Type Communication (mMTC), etc.

The 6G communication network can support various communication services and scenarios compared to the 5G communication network. The 6G communication network can satisfy requirements of hyper-performance, hyper-bandwidth, hyper-space, hyper-precision, hyper-intelligence, and/or hyper-reliability. The 6G communication network can support various and wide frequency bands and can be applied to various usage scenarios (e.g. terrestrial communication, non-terrestrial communication, sidelink communication, etc.).

Communication networks (e.g. 5G communication networks, 6G communication networks, etc.) can provide communication services to terminals located on the ground. The demand for communication services for not only terrestrial but also non-terrestrial aircrafts, drones, satellites, etc. is increasing, and for this purpose, technologies for non-terrestrial networks (NTNs) are being discussed. The NTN can be implemented based on 5G communication technologies, 6G communication technologies, etc. For example, in an NTN, communication between a satellite and a communication node located on the ground or a non-terrestrial communication node (e.g. airplane, drone, etc.) may be performed based on the 5G communication technology, 6G communication technology, etc. In an NTN, a satellite may perform functions of a base station in a communication network (e.g. 5G communication network, 6G communication network, etc.).

The satellites used in NTNs may be classified into low Earth orbit (LEO) satellites, medium Earth orbit (MEO) satellites, geostationary Earth orbit (GEO) satellites, high elliptical orbit (HEO) satellites, etc. depending on their relative altitudes and operational schemes. The satellites with lower altitudes (or low-orbit satellites) may have relative advantages in terms of transmission link capacity and communication delay. However, since the satellites with lower altitudes move faster in the sky, a Doppler effect may occur significantly. If a Doppler effect occurs at a level greater than that tolerated by conventional terrestrial network technology or non-terrestrial network technology, the quality of satellite-based communication may be significantly degraded. For this reason, techniques may be required to effectively compensate for a Doppler shift (DS) caused by the Doppler effect due to the relative speed between communication entities.

### DISCLOSURE

### Technical Problem

The present disclosure is directed to providing a method and an apparatus for effectively compensating for a DS in a non-terrestrial network.

### Technical Solution

An exemplary embodiment of an operation method of a first communication node accessing a terrestrial network (TN) and a non-terrestrial network (NTN), for achieving the above-described objective, may comprise: receiving, from a first TN cell, first linkage information including information on one or more NTN cells including at least a first NTN cell, in a coverage of the first TN cell overlapping with a coverage of the first NTN cell; identifying information on a location of a first satellite forming the first NTN cell and information on a location of a first reference point of the first NTN cell, which are included in the first linkage information; receiving, from the first NTN cell, a first signal to which a first Doppler shift (DS) pre-compensation is applied based on the location of the first reference point; and applying a first additional DS compensation to the received first signal, the first additional DS compensation being based on the location of the first satellite, the location of the first reference point, and a location of the first communication node.

The first linkage information may be generated based on second linkage information obtained by the first TN cell from a linkage management device connected to one or more TN cells including at least the first TN cell and the one or more NTN cells, and the second linkage information may be generated based on third linkage information obtained by the linkage management device from the one or more NTN cells.

The first linkage information may further include at least one of speed information of the first satellite, path information of the first satellite, and operation information of the first satellite.

The first DS pre-compensation applied to the first signal may be determined based on a distance between the first satellite and the first reference point.

The applying of the first additional DS compensation may comprise: identifying a first reception angle based on the location of the first reference point, the location of the first satellite, and the location of the first communication node; identifying a distance between the first reference point and the first communication node based on the location of the first reference point and the location of the first communication node; determining the first additional DS compensation based on the first reception angle and the location of the first reference point; and applying the determined first additional DS compensation to the first signal.

The operation method may further comprise: identifying information on a location of the first TN cell, before identifying the first reception angle; and identifying the location of the first communication node based on the information on the location of the first TN cell.

When the first linkage information further includes information on the location of the first TN cell, the information on the location of the first TN cell is information on a relative location of the first TN cell with respect to the location of the first reference point, and the identifying of the information on the location of the first TN cell may comprise: identifying information on an absolute location of the first TN cell based on the information on the location of the first TN cell.

The operation method may further comprise: after the applying of the first additional DS compensation, moving to a coverage of a second TN cell overlapping the coverage of the first NTN cell; receiving, from the second TN cell, fourth linkage information including information on one or more NTN cells including at least the first NTN cell in the coverage of the second TN cell; identifying information on an updated location of the first satellite and information on a location of a second reference point, which is an updated reference point of the first NTN cell, which are included in the fourth linkage information; receiving, from the first NTN cell, a second signal to which a second DS pre-compensation is applied, the second DS pre-compensation being based on the location of the second reference point; and applying a second additional DS compensation to the received second signal, the second additional DS compensation being based on the updated location of the first satellite, the location of the second reference point, and an updated location of the first communication node.

The operation method may further comprise: after the applying of the first additional DS compensation, moving to a coverage of a third TN cell overlapping a coverage of a second NTN cell different from the first NTN cell; receiving, from the third TN cell, fifth linkage information including information on one or more NTN cells including at least the second NTN cell in the coverage of the third TN cell; identifying information on a location of a second satellite forming the second NTN cell and information on a location of a third reference point, which is a reference point of the second NTN cell, which are included in the fifth linkage information; receiving, from the second NTN cell, a third signal to which a third DS pre-compensation is applied, the third DS pre-compensation being based on the location of the third reference point; and applying a third additional DS compensation to the received third signal, the third additional DS compensation being based on the location of the second satellite, the location of the third reference point, and the location of the first communication node.

An exemplary embodiment of an operation method of a first TN cell, in a communication system where a TN and an NTN coexist, for achieving the above-described objective, may comprise: receiving first linkage information including information on one or more NTN cells from a linkage management device connected to one or more TN cells including at least the first TN cell and the one or more NTN cells; identifying a first NTN cell corresponding to the first TN cell among the one or more NTN cells based on the first linkage information; generating second linkage information corresponding to the first NTN cell based on the first linkage information; and transmitting the second linkage information in downlink within a coverage of the first TN cell, wherein the second linkage information includes information on a location of a first satellite forming the first NTN cell and information on a location of a first reference point of the first NTN cell, and the information included in the second linkage information is used to determine an additional Doppler shift (DS) compensation to be applied to a first signal to which a DS pre-compensation is applied, the first signal being transmitted from the first NTN cell and received by each of one or more communication nodes receiving the second linkage information in downlink.

The operation method may further comprise: receiving, from the linkage management device, third linkage information including updated information on the one or more NTN cells, after transmitting the second linkage information in downlink; generating fourth linkage information including updated information on the first NTN cell corresponding to the first TN cell based on the third linkage information; and transmitting the fourth linkage information in downlink within the coverage of the first TN cell.

The operation method may further comprise: receiving, from the linkage management device, fifth linkage information including updated information on the one or more NTN cells, after transmitting the second linkage information in downlink; identifying a second NTN cell corresponding to the first TN cell and different from the first NTN cell among the one or more NTN cells based on the fifth linkage information; generating sixth linkage information corresponding to the second NTN cell based on the fifth linkage information; and transmitting the sixth linkage information in downlink within the coverage of the first TN cell.

The operation method may further comprise: transmitting seventh linkage information to the linkage management device, wherein the seventh linkage information may include at least one of information on the first TN cell and information on one or more communication nodes connected to the first TN cell.

The second linkage information may further include information on the location of the first TN cell, and the information on the location of the first TN cell may be used by each of one or more communication nodes receiving the second linkage information in downlink to identify a location of the each of one or more communication nodes.

The information on the location of the first TN cell may be information on a relative location of the first TN cell with respect to the location of the first reference point, and an absolute location of the first TN cell may be identified based on the information on the location of the first TN cell and the information on the location of the first reference point.

An exemplary embodiment of an operation method of a linkage management device, in a communication system where a TN and an NTN coexist, for achieving the above-described objective, may comprise: receiving first linkage information on one or more NTN cells from the one or more NTN cells connected to the linkage management device; identifying information on a first NTN cell corresponding to a first TN cell among the one or more NTN cells based on the first linkage information; generating second linkage information corresponding to the first NTN cell based on the first linkage information; and transmitting the second linkage information to the first TN cell, wherein the second linkage information includes information on a location of a first satellite forming the first NTN cell and information on a location of a first reference point of the first NTN cell, and the information included in the second linkage information is used to determine an additional Doppler shift (DS) compensation to be applied to a first signal to which a DS pre-compensation is applied, the first signal being transmitted from the first NTN cell and received by each of one or more communication nodes within a coverage of the first TN cell.

The operation method may further comprise: receiving, from the one or more NTN cells, third linkage information including updated information on the one or more NTN cells, after transmitting the second linkage information; generating fourth linkage information including updated information on the first NTN cell corresponding to the first TN cell based on the third linkage information; and transmitting the fourth linkage information to the first TN cell.

The operation method may further comprise: receiving fifth linkage information including updated information on the one or more NTN cells, after transmitting the second linkage information; identifying a second NTN cell corresponding to the first TN cell and different from the first NTN cell among the one or more NTN cells based on the fifth linkage information; generating sixth linkage information corresponding to the second NTN cell based on the fifth linkage information; and transmitting the sixth linkage information to the first TN cell.

The operation method may further comprise: receiving seventh linkage information from the first TN cell, wherein the seventh linkage information may include at least one of information on the first TN cell and information on one or more communication nodes connected to the first TN cell.

### Advantageous Effects

According to an exemplary embodiment of the method and apparatus for Doppler shift compensation in a communication system, in a communication environment where a TN and an NTN coexist, one or more TN cells can obtain linkage information including information on one or more NTN cells having coverages overlapping with its own coverage, from a linkage management device. The one or more TN cells may transmit the obtained linkage information to a first communication node (user, terminal, ground/air vehicle, etc.) connected to the one or more TN cells. The information on one or more satellites forming the one or more NTN cells can be identified. The one or more NTN cells may transmit a first signal to which DS pre-compensation is applied based on each reference point of the one or more TN cells, to the first communication node. The first communication node may apply additional DS compensation to the first signal. As a result, DS compensation can be effectively performed in the communication environment where the TN and NTN coexist.

### DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of a communication system including a non-terrestrial network.

FIGS. 5A to 5C are conceptual diagrams for describing a Doppler shift (DS) occurrence phenomenon due to a Doppler effect.

FIGS. 6A to 6C are conceptual diagrams illustrating a second exemplary embodiment of a communication system including a non-terrestrial network.

FIG. 7 is a sequence chart for describing a first exemplary embodiment of a signaling method in a communication system.

FIG. 8 is a sequence chart for describing a second exemplary embodiment of a signaling method in a communication system.

FIG. 9 is a conceptual diagram for describing a first exemplary embodiment of a DS compensation method in a communication system.

FIG. 10 is a conceptual diagram for describing a second exemplary embodiment of a DS compensation method in a communication system.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

In the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted. In addition to exemplary embodiments explicitly described in the present disclosure, operations according to combinations of the exemplary embodiments, extensions of the exemplary embodiments, and/or modifications of the exemplary embodiments may be performed. The performance of some operations may be omitted, and a sequence in which operations are performed may be changed.

In exemplary embodiments, even if a method (e.g. transmission or reception of a signal) performed by a first communication node among communication nodes is described, a second communication node corresponding thereto may perform a method (e.g. reception or transmission of the signal) corresponding to the method performed by the first communication node. That is, if an operation of a user equipment (UE) is described, a corresponding base station may perform an operation corresponding to the operation of the UE. Conversely, if an operation of a base station is described, a corresponding UE may perform an operation corresponding to the operation of the base station. In a non-terrestrial network (NTN) (e.g. payload-based NTN), an operation of a base station may refer to an operation of a satellite, and an operation of the satellite may refer to an operation of the base station.

A base station may be referred to as a node B (NodeB), evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, or the like. A UE may be referred to as a terminal, device, apparatus, node, communication node, end node, access terminal, mobile terminal, station, subscriber station, mobile station, portable subscriber station, on-broad unit (OBU), or the like.

In the present disclosure, signaling may be at least one of higher layer signaling, medium access control (MAC) signaling, or physical (PHY) signaling. A message used for higher layer signaling may be referred to as a higher layer message or a higher layer signaling message. A message used for MAC signaling may be referred to as a MAC message or a MAC signaling message. A message used for PHY signaling may be referred to as a PHY message or a PHY signaling message. The higher layer signaling may refer to transmission and reception operations of system information (e.g. master information block (MIB), system information block (SIB)) and/or RRC messages. The MAC signaling may refer to transmission and reception operations of MAC control elements (CEs). The PHY signaling may refer to transmission and reception operations of control information (e.g. downlink control information (DCI), uplink control information (UCI), sidelink control information (SCI)).

In the present disclosure, ‘configuration of an operation (e.g. transmission operation)’ may refer to signaling of ‘control information (e.g. information element, parameter) for the operation’ and/or ‘information indicating to perform the operation’. ‘An information element (e.g. parameter) is configured’ may mean that the corresponding information element is signaled. In the present disclosure, ‘signal and/or channel’ may refer to a signal, channel, or signal and channel, and ‘signal’ may be used to mean ‘signal and/or channel’.

A communication system may include at least one of a terrestrial network, a non-terrestrial network, a 4G communication network (e.g. long-term evolution (LTE) communication network), a 5G communication network (e.g. new radio (NR) communication network), or a 6G communication network. Each of the 4G communication network, the 5G communication network, and the 6G communication network may include a terrestrial network and/or a non-terrestrial network. The non-terrestrial network may operate based on at least one communication technology of the LTE communication technology, the 5G communication technology, or the 6G communication technology. The non-terrestrial network may provide communication services in various frequency bands.

A communication network to which exemplary embodiments are applied is not limited to what is described below, and exemplary embodiments may be applied to various communication networks (e.g. 4G communication network, 5G communication network, and/or 6G communication network). Here, a communication network may be used in the same meaning as a communication system.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

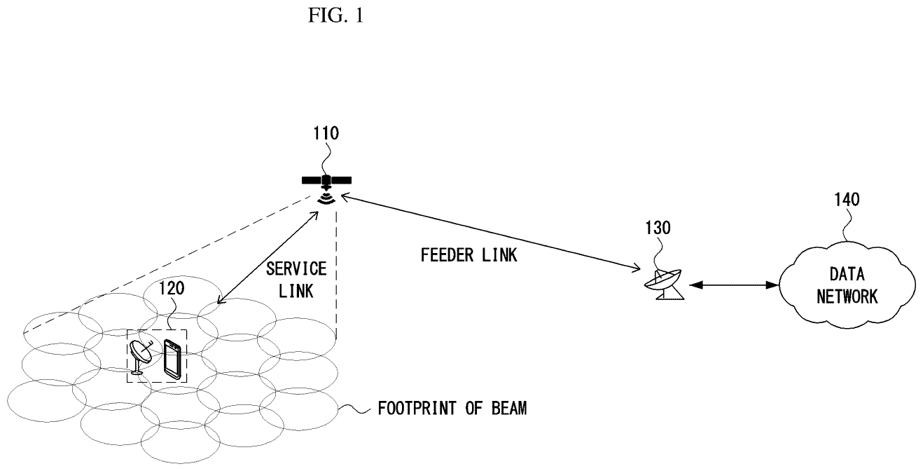

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

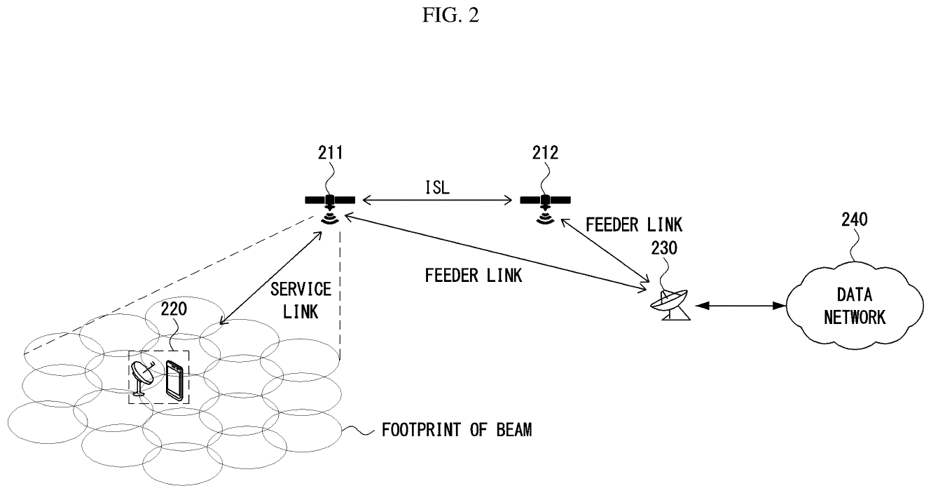

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows. In the present disclosure, the entity may be referred to as ‘communication node’.

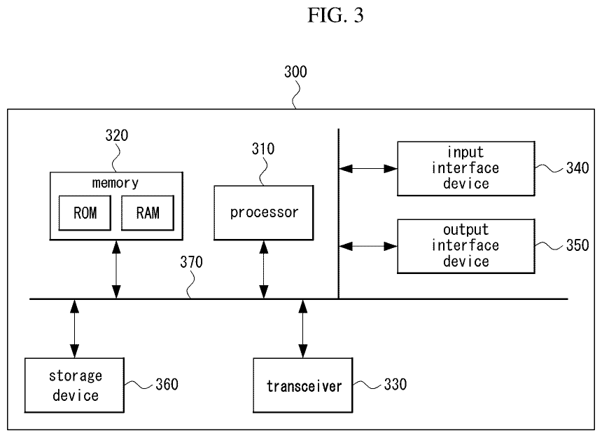

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’.

Parameters for the scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |
| | | | 1,200 | km |
| Spectrum (service link) | <6 GHz (e.g. 2 GHz) | | | |
| | >6 GHz (e.g. DL 20 GHz, UL 30 GHz) | | | |
| Maximum channel | 30 MHz for band <6 GHz | | | |
| bandwidth capability | 1 GHz for band >6 GHz | | | |
| (service link) | | | | |

| Maximum distance between | 40,581 | km | 1,932 km (altitude of 600 |
|---|---|---|---|
| satellite and communication | | | km) |
| node (e.g. UE) at the | | | 3,131 km (altitude of 1,200 |
| minimum elevation angle | | | km) |
| Maximum round trip delay | Scenario A: 541.46 ms | | Scenario C: (transparent |
| (RTD) (only propagation | (service and feeder links) | | payload: service and feeder |
| delay) | Scenario B: 270.73 ms | | links) |
| | (only service link) | | −5.77 ms (altitude of 600 km) |
| | | | −41.77 ms (altitude of 1,200 |
| | | | km) |
| | | | Scenario D: (regenerative |
| | | | payload: only service link) |
| | | | −12.89 ms (altitude of 600 |
| | | | km) |
| | | | −20.89 ms (altitude of 1,200 |
| | | | km) |
| Maximum delay variation | 16 | ms | 4.44 ms (altitude of 600 km) |
| within a single beam | | | 6.44 ms (altitude of 1,200 |
| | | | km) |
| Maximum differential delay | 10.3 | ms | 3.12 ms (altitude of 600 km) |
| within a cell | | | 3.18 ms (altitude of 1,200 |
| | | | km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C | Scenario D |
|---|---|---|---|---|
| Satellite altitude | 35,786 km | | 600 km | |
| Maximum RTD in a | 541.75 ms | 270.57 ms | 28.41 ms | 12.88 ms |
| radio interface | (worst case) | | | |
| between base station | | | | |
| and UE | | | | |
| Minimum RTD in a | 477.14 ms | 238.57 ms | 8 ms | 4 ms |
| radio interface | | | | |
| between base station | | | | |
| and UE | | | | |

Hereinafter, Doppler shift compensation methods in a communication system will be described. Even if a method (e.g. transmission or reception of a signal) performed by a first communication node among communication nodes is described, a second communication node corresponding thereto may perform a method (e.g. reception or transmission of the signal) corresponding to the method performed by the first communication node. That is, if an operation of a terminal is described, a base station (or satellite) corresponding thereto may perform an operation corresponding to the operation of the terminal. Conversely, if an operation of a base station (or satellite) is described, a terminal corresponding thereto may perform an operation corresponding to the operation of the base station (or satellite).

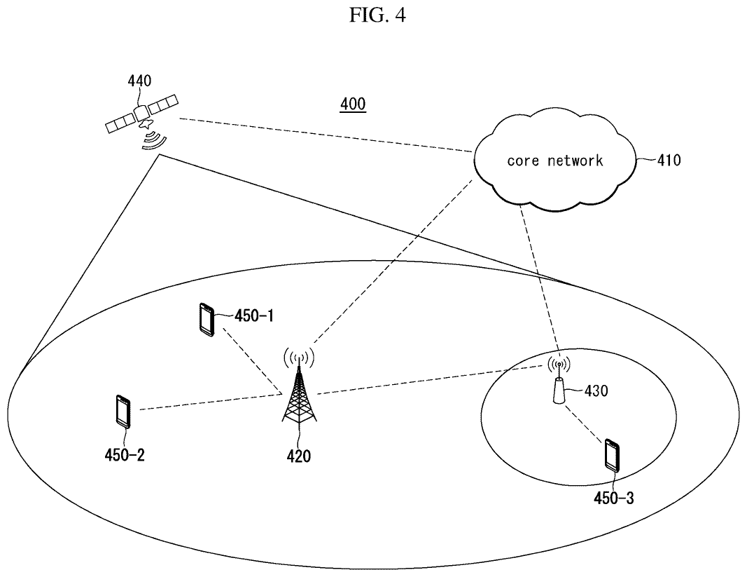

FIG. 4 is a conceptual diagram illustrating a first exemplary embodiment of a communication system including a non-terrestrial network.

Referring to FIG. 4, a communication system 400 may include a core network (CN) 410 and an access network. Here, the communication system 400 may be configured identically or similarly to the communication system 100 described with reference to FIG. 1. The core network 410 may be configured identically or similarly to the core network described with reference to FIG. 1. The core network 410 supporting 4G communication may include an MME, S-GW, P-GW, etc. The core network 410 supporting 5G communication may include an AMF, UPF, P-GW, etc. The access network may include one or more base stations 420, 430, and 440 and one or more terminals 450-1, 450-2, and 450-3. The one or more terminals 450-1, 450-2, and 450-3 may receive communication services in a wired or wireless communication manner. The one or more terminals 450-1, 450-2, and 450-3 may be communication nodes constituting the communication system 400 and may be configured identically or similarly to the communication node 300 illustrated in FIG. 3.

The one or more base stations 420, 430, and 440 of the communication system 400 may include one or more terrestrial base stations 420 and 430 and one or more non-terrestrial base stations 440. The access network of the communication system 400 may include a terrestrial network and a non-terrestrial network. The terrestrial network (TN) of the communication system 400 may refer to a network that provides communication services to the one or more terminals 450-1, 450-2, and 450-3 within a predetermined communication coverage by using one or more terrestrial base stations 420 and 430. The non-terrestrial network (NTN) of the communication system 400 may refer to a network that provides communication services to one or more terminals 450-1, 450-2, and 450-3 within a predetermined communication coverage by using one or more non-terrestrial base stations 440.

The one or more terrestrial base stations 420 and 430 may include the macro base station 420, small base station 430, etc. The macro base station 420 and/or the small base station 430 may be connected to an end node of the core network 410 through a wired backhaul link or a wireless backhaul link. The one or more non-terrestrial base stations 440 may correspond to a type of satellite base station. For example, the non-terrestrial base station 440 may be a base station mounted on a geostationary satellite, and may be connected to an end node of the core network 410 through a wireless backhaul link via a terrestrial base station (not shown), etc. In FIG. 4, for convenience of description, an exemplary embodiment is illustrated in which the one macro base station 420, one small base station 430, and one non-terrestrial base station 440 are each deployed in the communication system 400, but exemplary embodiments of the present disclosure are not limited thereto. For example, the communication system 400 may include a plurality of macro base stations, small base stations, and/or non-terrestrial base stations. Alternatively, the communication system 400 may include communication nodes identical or similar to a BBU block and/or TRP described with reference to FIG. 1. For example, the TRP may support a remote wireless transmission/reception function among all functions of a communication protocol, and a baseband processing function for the TRP may be performed in the BBU block. The BBU block may belong to the access network or core network. The BBU block may be located in the AMF, UPF, MME, S-GW, or macro base station. Alternatively, the BBU block may be located independently of each of the AMF, UPF, MME, S-GW, and macro base station. For example, the BBU block may be configured as a logical function block between the macro base station and the AMF (or UPF). The BBU block may support multiple TRPs, and may be connected to each of the multiple TRPs using a wired fronthaul link or a wireless fronthaul link. A link between the BBU block and the TRP may be referred to as a ‘fronthaul link’. Each TRP may be connected to the BBU block through a wired fronthaul link or a wireless fronthaul link, and may provide communication services to a terminal within a predetermined communication possible area based on a communication protocol (e.g. 4G communication protocol or 5G communication protocol).

The one or more base stations 420, 430, and 440 may be connected to the core network 410 (e.g. AMF, UPF, MME, S-GW, etc.) using a wired backhaul link or a wireless backhaul link. The one or more base stations 420, 430, and 440 may provide communication services to terminals 450-1, 450-2, and 450-3 within cell coverages based on a predetermined communication protocol (e.g. 4G communication protocol, 5G communication protocol, etc.). Here, the macro base station 420 may form a relatively wide cell coverage compared to the small base station 430.

The one or more base stations 420, 430, and 440 may be directly connected to the terminals 450-1, 450-2, and 450-3 within the cell coverages through wireless communication to provide communication services, or may provide communication services indirectly through other communication nodes. For example, the macro base station 420 may provide communication services by being directly connected to the first terminal 450-1, second terminal 450-2, etc., which are easy to communicate with directly among the terminals within the cell coverage. On the other hand, the macro base station 420 may be connected to the small base station 430 through a wireless backhaul link, and may indirectly provide communication services to the third terminal 450-3.

Recently, the demand for wired or wireless communication traffic has been explosively increasing, and it is predicted that the demand for traffic will further increase in the future for industrial needs and/or use in multimedia services. In a situation where the demand for traffic continues to increase, techniques for performing communication using one or more types of communication networks are being studied in order to achieve the requirements of communication system standards and/or improve the quality of communication services. For example, communication techniques utilizing a heterogeneous network (HetNet) that performs communication using multiple types of communication networks that use different radio access technologies (RATs) are being studied.

In a communication system using a heterogeneous network, multiple communication networks of different types or different layers may coexist. For example, in the communication system using the heterogeneous network, a wired communication network and a wireless communication network may coexist. Alternatively, in the communication system using the heterogeneous network, a terrestrial network and a wireless network may coexist. Alternatively, in the communication system using the heterogeneous network, a communication network using a relatively low frequency band and a communication network using a relatively high frequency band (such as millimeter wave band) may coexist. However, these are merely examples for convenience of description, and exemplary embodiments of the present disclosure may be applied identically or similarly to exemplary embodiments of more diverse heterogeneous networks.

Satellites used in NTNs may be classified into low earth orbit (LEO) satellites, medium earth orbit (MEO) satellites, geostationary earth orbit (GEO) satellites, high elliptical orbit (HEO) satellites, etc. depending on relative altitudes, operation schemes, etc. The lower the altitude of the satellite (or the low-orbit satellite), the greater the relative advantage in terms of transmission link capacity and communication delay. However, the lower the altitude of the satellite, the faster the satellite moves in the sky, and the greater the Doppler effect may occur. If the Doppler effect occurs at a level greater than that tolerable in conventional terrestrial network technology or non-terrestrial network technology, the satellite-based communication quality may be significantly degraded. Techniques may be required to effectively compensate for the Doppler shift (DS) due to the Doppler effect caused by the relative speed between communication entities.

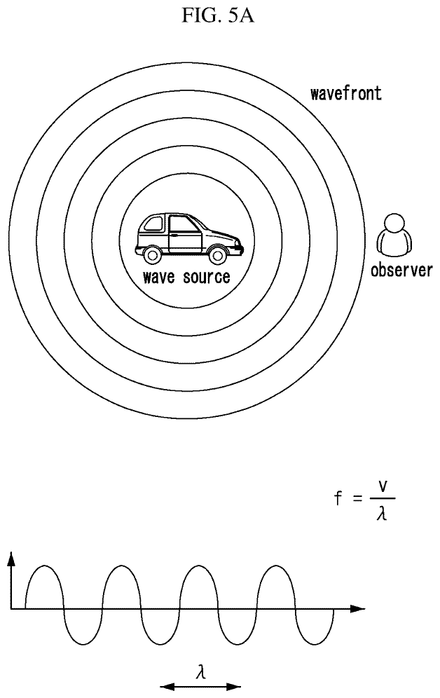

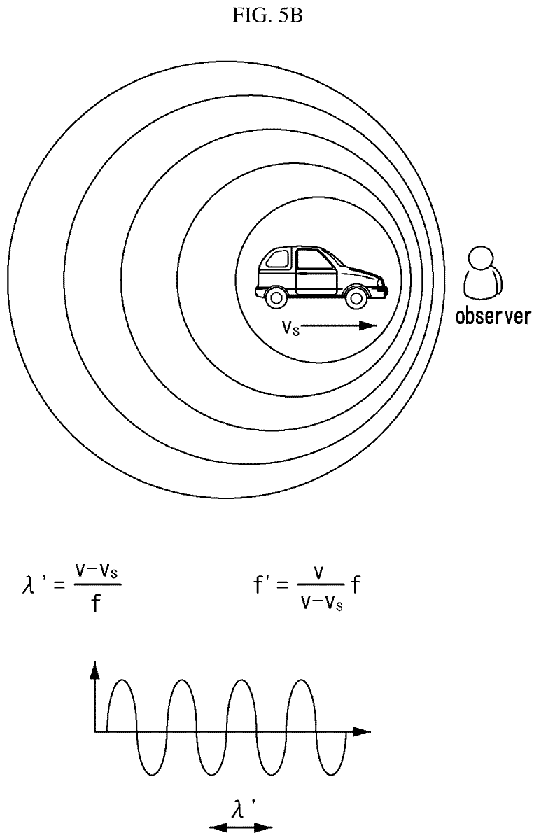

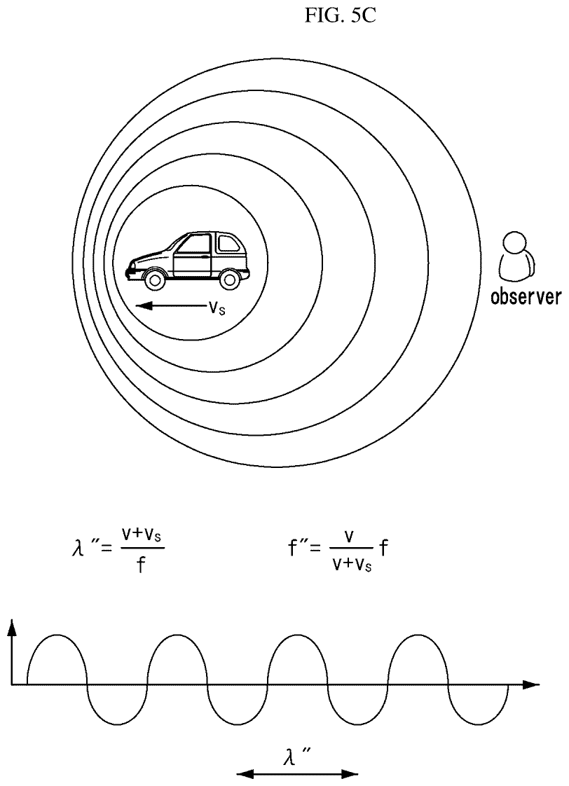

FIGS. 5A to 5C are conceptual diagrams for describing a Doppler shift (DS) occurrence phenomenon due to a Doppler effect.

Referring to FIGS. 5A to 5C, a Doppler effect may occur when at least one of communication entities moves in the communication system. When the Doppler effect occurs, a DS may occur in a wireless signal transmitted and received between the communication entities, and a frequency and wavelength of the wireless signal may shift (or change).

Referring to FIG. 5A, a wave source may generate and transmit a transmission wave. The transmission wave having a speed v may have a first wavelength λ and a first frequency f. Here, the speed v, the first wavelength Δ, and the first frequency f of the transmission wave may have a relationship as shown in Equation 1 below.

$$[ Equation 1 ]$$

$$f = \frac{v}{λ} \qquad [ 91 ]$$

When the wave source does not move, wavefronts of the transmission wave may form a certain shape (e.g. concentric circle shape). A wavelength and frequency of a wave (i.e. reception wave) received and/or observed from an observer's perspective may be equal to the first wavelength λ and the first frequency f, which are the same as the wavelength and frequency of the transmission wave. When the relative speed between the wave source and the observer is 0, the wavelengths and frequencies of the transmission wave and the reception wave may be the same.

Referring to FIG. 5B, when the wave source moves toward the observer at a speed vₛ (or, when the wave source and the observer approach at a relative speed vₛ), the wavelengths and frequencies of the transmission wave and the reception wave may be different. Specifically, the wavelength and frequency of the transmission wave having the speed v may be the first wavelength λ and the first frequency f. On the other hand, the wavelength and frequency of the reception wave may be a second wavelength λ′ and a second frequency f′. Here, the second wavelength λ′ may be determined as in Equation 2 according to the Doppler effect.

$$[ Equation 2 ]$$

$${λ}^{′} = \frac{v - {v}_{s}}{f} \qquad [ 95 ]$$

The second frequency f′ may be calculated as in Equation 3 based on Equation 2.

$$[ Equation 3 ]$$

$${f}^{′} = \frac{v}{{λ}^{′}} = \frac{v}{v - {v}_{s}} f \qquad [ 98 ]$$

Referring to FIG. 5C, when the wave source moves at a speed vₜ in the opposite direction to the observer (or, when the wave source and the observer move away at a relative speed vₜ), the wavelengths and frequencies of the transmission wave and the reception wave may be different. Specifically, the wavelength and frequency of the transmission wave having a speed v may be the first wavelength λ and the first frequency f. On the other hand, the wavelength and frequency of the reception wave may be a third wavelength λ″ and a third frequency f″. Here, the third wavelength λ″ may be determined according to the Doppler effect as in Equation 4 below.

$$[ Equation 4 ]$$

$${λ}^{″} = \frac{v + {v}_{t}}{f} \qquad [ 101 ]$$

The third frequency f″ may be calculated as in Equation 5 based on Equation 4.

$$[ Equation 5 ]$$

$${f}^{″} = \frac{v}{{λ}^{″}} = \frac{v}{v + {v}_{t}} f \qquad [ 104 ]$$

As in Equation 3 or Equation 5, when the frequency f of the transmission wave and the frequency f′ or f″ of the reception wave are determined differently, it can be seen that a DS has occurred. Since the directions of vₛ and vₜ in Equations 3 and 5 are opposite, Equations 3 and 5 can be seen as practically the same equation when ‘vₛ=−vₜ’ is considered.

DS f_{d} may be defined as a difference between the frequency of the reception wave and the frequency of the transmission wave. For example, it may be calculated as Equation 6 based on Equation 3 (or Equation 5).

$$[ Equation 6 ]$$

$${f}_{d} = {f}^{′} - f = ( \frac{v}{v \pm {v}_{s}} f - f ) = ( \frac{v}{v \pm {v}_{s}} - 1 ) f = \frac{v - ( v \pm {v}_{s} )}{v \pm {v}_{s}} f = \frac{∓ {v}_{s}}{v \pm {v}_{s}} f \qquad [ 108 ]$$

A speed v of a wireless signal (i.e. electromagnetic wave) transmitted and received in a communication system may be a speed of light c (approximately 3× 10⁸ m/s). When the relative speed between communicating entities is expressed as a vector \vec{v}, the DS f_{d} caused by the relative speed \vec{v} between communication entities may be expressed as in Equation 7.

$$[ Equation 7 ]$$

$${f}_{d} = - \frac{\vec{v} \cdot \vec{n}}{c} f \qquad [ 111 ]$$

In Equation 7, \vec{n} may be a unit vector indicating the direction of propagation of the signal. As in Equation 7, the greater the relative speed between communication entities, the greater the Doppler effect and the resulting DS value.

Satellites used in non-terrestrial networks may be classified into LEO satellites, MEO satellites, GEO satellites, and HEO satellites, depending on relative altitudes, operation schemes, etc. Satellites with lower altitudes (or low-orbit satellites) may have relative advantages in terms of transmission link capacity and communication delay. However, the lower the altitude of the satellite, the faster the satellite moves in the sky, so the greater the Doppler effect may occur. For example, a satellite located at an altitude of 600 km may have a moving speed of approximately 7.6 km/s=27,360 km/h. A relative speed between a satellite moving at a high speed in the sky and a communication entity on the ground may be very large, and thus a Doppler effect (and a DS according thereto) may appear very large. If the Doppler effect occurs at a level greater than a tolerable level in conventional terrestrial network technology or non-terrestrial network technology, the quality of satellite-based communication may be significantly degraded. Techniques may be required to effectively compensate for the DS due to the Doppler effect caused by the relative speed between the communication entities.

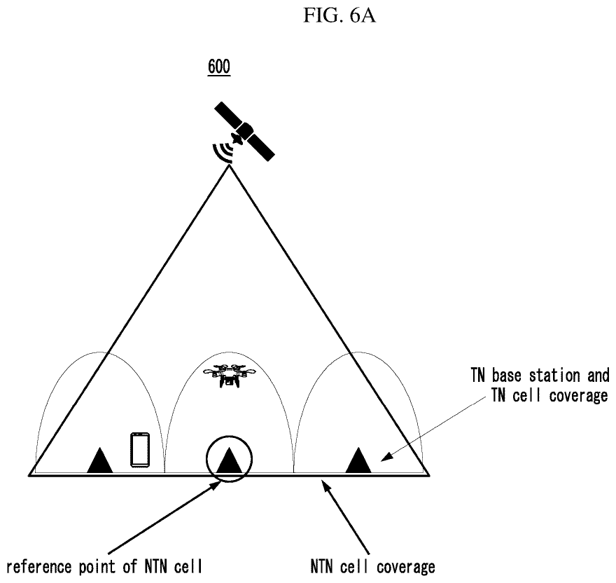

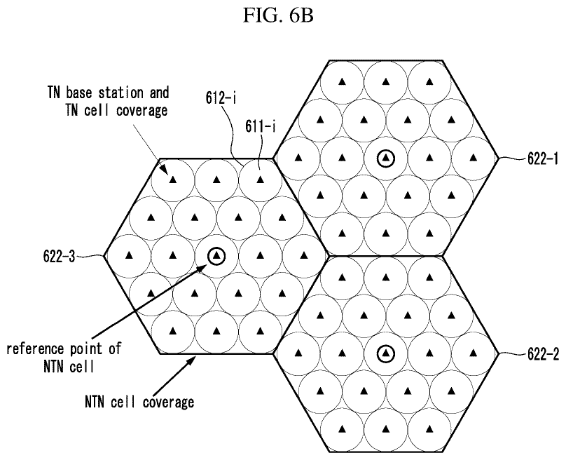

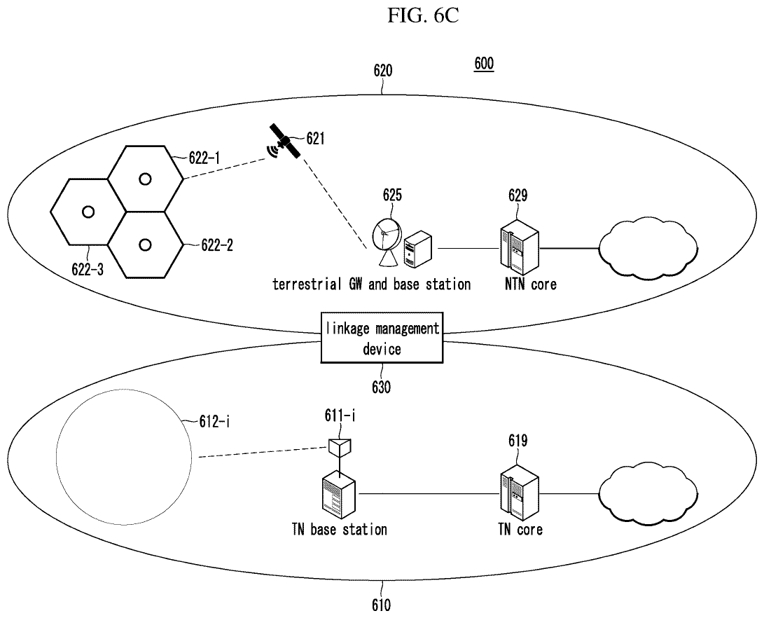

FIGS. 6A to 6C are conceptual diagrams illustrating a second exemplary embodiment of a communication system including a non-terrestrial network.

Referring to FIGS. 6A to 6C, a communication system may include a terrestrial network (TN) and a non-terrestrial network (NTN). In the communication system including the TN and NTN, a first communication node (user, terminal, ground/airborne vehicle, etc.) may access the TN and/or NTN.

Referring to FIG. 6A, one or more NTN cells in the communication system 600 may be formed by non-terrestrial communication entity(ies). FIG. 6A illustrates a situation in which the non-terrestrial communication entity is a satellite. However, this is merely an example for convenience of description, and exemplary embodiments of a communication system including an NTN are not limited thereto. For example, configurations described for a ‘satellite’ in the present disclosure may be applied to a ‘UAS system’ in the same or similar manner.

In an exemplary embodiment of the communication system 600, one or more NTN cells and one or more TN cells may overlap. For example, a first satellite may form one or more NTN cells in a specific area on the ground (i.e. one or more NTN cell coverages) from a satellite orbit. The one or more NTN cells formed in this manner may refer to, for example, Earth-fixed cells of a low-orbit satellite. However, this is merely an example for convenience of description, and exemplary embodiments of a communication system including an NTN are not limited thereto. Each of the one or more NTN cells may have a predetermined reference point.

Each of the one or more TN base stations may form a TN cell in a specific area on the ground (i.e. TN cell coverage). The one or more NTN cell coverages may be larger than the one or more TN cell coverages. The cell coverages of the one or more TN cells and the cell coverages of the one or more NTN cells may overlap. For example, one NTN cell coverage may include or overlap one or more TN cell coverages. One TN cell coverage may overlap one or more NTN cell coverages.

Referring to FIG. 6B, the communication system 600 may have one or more NTN cells and one or more TN cells. FIG. 6B illustrates a situation in which one or more satellites form three NTN cells 622-1, 622-2, and 622-3, a plurality of TN base stations 611-i form a plurality of TN cells 612-i, and cell coverages of the plurality of TN cells 611-i are included in or overlapped with each of cell coverages of the NTN cells 622-1, 622-2, and 622-3. However, this is merely an example for convenience of description, and exemplary embodiments of a communication system including an NTN are not limited thereto.

Each of the NTN cells 622-1, 622-2, and 622-3 may have a predetermined reference point within the NTN cell coverage. Here, the reference point of each of the one or more NTN cells may refer to a center point (or a point corresponding thereto) of the cell coverage of each of the one or more NTN cells. However, this is merely an example for convenience of description, and exemplary embodiments of a communication system including an NTN are not limited thereto.

Referring to FIG. 6C, the communication system 600 may include a TN 610 and an NTN 620. In the TN 610, one or more TN base stations 611-i may form one or more TN cells 612-i. One or more TN base stations 611-i may be connected to one or more TN cores 619 and may be connected to a communication network through the one or more TN cores 619. Accordingly, a first communication node may connect to the communication network by connecting to the one or more TN cells 612-i.

Meanwhile, in the NTN 620, one or more satellites 621 may form one or more NTN cells 622-1, 622-2, and 622-3. The one or more satellites 621 may be connected to one or more NTN cores 629 through one or more terrestrial gateways (GWs) and base stations 625, and may be connected to a communication network through the one or more NTN cores 629. Accordingly, the first communication node may connect to the communication network by connecting to the one or more TN cells 622-1, 622-2, and 622-3.

The communication system 600 may include a linkage management device 630 that manages a correspondence relationship, linkage, etc. between the cells of the TN 610 and the cells of the NTN 620. For example, the linkage management device 630 may perform a satellite control function and/or a network linkage control function. According to the network linkage control function, the linkage management device 630 may identify and/or manage information on the correspondence relationship (such as mapping relationship, inclusion relationship, overlapping relationship, etc.) between the TN cells and the NTN cells. The linkage management device 630 may identify and/or manage information on each of the NTN cells. Here, the information on each of the NTN cells may include the location of the reference point (such as center point) of each of the NTN cells, the position, speed, passage time over a specific point, and/or operation information of one or more satellites forming the NTN cells, etc. The link management device 630 may further perform a function of delivering information (control information, signaling, etc.) between the TN 610 and the NTN 620.

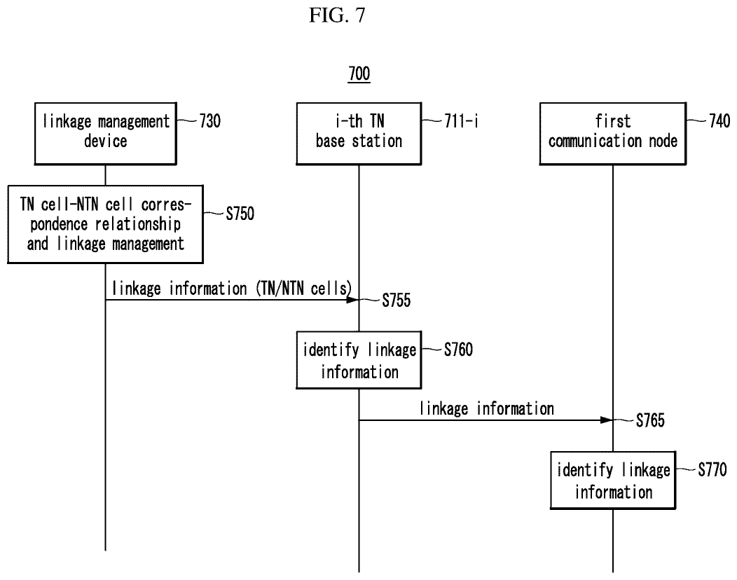

FIG. 7 is a sequence chart for describing a first exemplary embodiment of a signaling method in a communication system.

Referring to FIG. 7, a communication system may include a TN and an NTN. The TN may include one or more TN cells formed by one or more TN base stations. The NTN may include one or more NTN cells formed by one or more satellites (or UAS systems, etc.). The communication system may further include a linkage management device for managing a correspondence relationship and linkage between the TN cells and the NTN cells. Here, the linkage management device may be the same as or similar to the linkage management device 630 described with reference to FIG. 6. Hereinafter, in describing a first exemplary embodiment of a signaling method in a communication system with reference to FIG. 7, descriptions redundant with those described with reference to FIGS. 1 to 6C may be omitted.

In the communication system 700, a TN cell coverage formed by the i-th TN base station 711-i may be included in or overlapped with cell coverages of one or more NTN cells. In other words, the i-th TN cell formed by the i-th TN base station 711-i may correspond to one or more NTN cells. As described above, a correspondence relationship (e.g. mapping relationship, inclusion relationship, overlapping relationship, etc.) may be formed between the TN cells and the NTN cells.

In the communication system 700, the linkage management device 730 may perform management of the correspondence relationship and/or linkage between one or more TN cells and one or more NTN cells (S750). To this end, the linkage management device 730 may be directly or indirectly connected to the one or more TN cells and one or more NTN cells.

The linkage management device 730 may transmit linkage information generated based on the management operation in step S750 to the i-th TN base station 711-i (S755). The linkage information transmitted in step S755 may include information on the correspondence relationship between the one or more TN cells and one or more NTN cells and/or information on the linkage between the one or more TN cells and one or more NTN cells. The i-th TN base station 711-i may receive the linkage information transmitted from the linkage management device 730 (S755).

The linkage information transmission and reception operation in step S755 may be performed based on an Operation, Administration, and Maintenance (OAM) function or a Self-Organizing-Network (SON) function supported by the communication system 700 or the linkage management device 730. Alternatively, the linkage information transmission and reception operation in step S755 may be performed based on a separate interface or a separately defined signaling procedure. The linkage information transmission and reception operation in step S755 may be performed periodically and/or aperiodically. For example, the linkage information transmission and reception operation in step S755 may be performed periodically based on a predetermined periodicity. Meanwhile, the linkage information transmission and reception operation in step S755 may be performed aperiodically based on a predetermined trigger (e.g. when a change occurs in the linkage information, when an access or handover of a terminal occurs, etc.).

The i-th TN base station 711-i may identify the linkage information received from the linkage management device 730 (S760). The i-th TN base station 711-i may obtain information on the correspondence relationship between the one or more TN cells and one or more NTN cells and/or information on the linkage between the one or more TN cells and one or more NTN cells based on the received and identified linkage information. For example, the i-th TN base station 711-i may obtain information on one or more NTN cells having a correspondence relationship with itself. Here, the information on the one or more NTN cells may include the location of the reference point (e.g. center point) of each NTN cell, the location, speed, passage time over a specific point, and/or operation information of one or more satellites forming the NTN cells. Alternatively, the i-th TN base station 711-i may obtain information on a correspondence relationship between a plurality of TN cells and a plurality of NTN cells managed by the linkage management device 730 in the communication system 700.

The i-th TN base station 711-i may transmit linkage information including at least a part of the information obtained in step S760 to the first communication node 740 connected to the cell of the i-th TN base station 711-i (S765). The linkage information transmitted in step S765 may include at least a part of information on the one or more NTN cells having the corresponding relationship with the i-th TN base station 711-i. Alternatively, the linkage information transmitted in step S765 may include at least a part of information on a plurality of TN cells managed by the linkage management device 730 and a corresponding relationship between the plurality of NTN cells. The first communication node 740 may receive the linkage information transmitted from the i-th TN base station 711-i (S765).

In step S765, the linkage information may be transmitted and received through system information (SIB, MIB, etc.). Alternatively, the linkage information may be transmitted and received via radio resource control (RRC) signaling used for procedures such as access, movement, and location information update. Alternatively, the linkage information may be transmitted and received based on a signaling procedure separately defined for transmitting and receiving the linkage information. The linkage information transmission and reception operation in step S765 may be performed periodically and/or aperiodically. For example, the linkage information transmission and reception operation in step S765 may be performed periodically based on a predetermined periodicity. Meanwhile, the linkage information transmission and reception operation in step S765 may be performed aperiodically based on a predetermined trigger (e.g. when a change occurs in the linkage information, when an access or handover of the first communication node 740 occurs, etc.).

The linkage information transmission and reception operation in step S765 may be performed based on an OAM function or a SON function supported by the communication system 700 or the linkage management device 730. Alternatively, the linkage information transmission and reception operation in step S765 may be performed based on a separate interface or a separately defined signaling procedure. The linkage information transmission and reception operation in step S765 may be performed periodically and/or aperiodically. For example, the linkage information transmission and reception operation in step S765 may be performed periodically based on a predetermined periodicity. Meanwhile, the linkage information transmission and reception operation in step S765 may be performed aperiodically based on a predetermined trigger (e.g. when a change occurs in the linkage information, when an access or handover of a terminal occurs, etc.).

The first communication node 740 may identify the linkage information received from the i-th TN base station 711-i (S770). As a result, the first communication node 740 may recognize or predict at least which TN cell's cell coverage and which NTN cell's cell coverage the first communication node 740 will be located in based on its own location (or movement path).

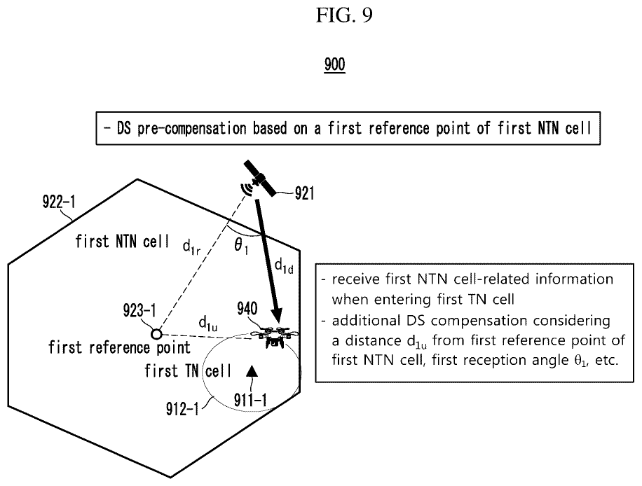

The first communication node 740 may perform communication with one or more NTN cells (or satellites forming one or more NTN cells) that have the corresponding relationship with the i-th TN base station 711-i based on the linkage information obtained in step S770. The operation of the first communication node 740 will be described in more detail below with reference to FIG. 9.

The linkage information transmitted and received in step S765 may include information on the location of the i-th TN base station 711-i. The information on the location of the i-th TN base station 711-i may be information on an absolute location. Alternatively, the information on the location of the i-th TN base station 711-i may be information on a relative location. Here, the information on the location of the i-th TN base station 711-i may be, for example, information on a relative location with respect to a reference point of a specific NTN cell. The first communication node 740 may identify the information on the location of the i-th TN base station 711-i included in the linkage information received in step S765. The first communication node 740 may identify an absolute location of the i-th TN base station 711-i based on the information on the location of the i-th TN base station 711-i included in the linkage information received in step S765 (i.e. information on the relative location with respect to the reference point of the specific NTN cell) and the information on the reference point of the specific NTN cell. The first communication node 740 may identify its own location based on the location of the i-th TN base station 711-i.

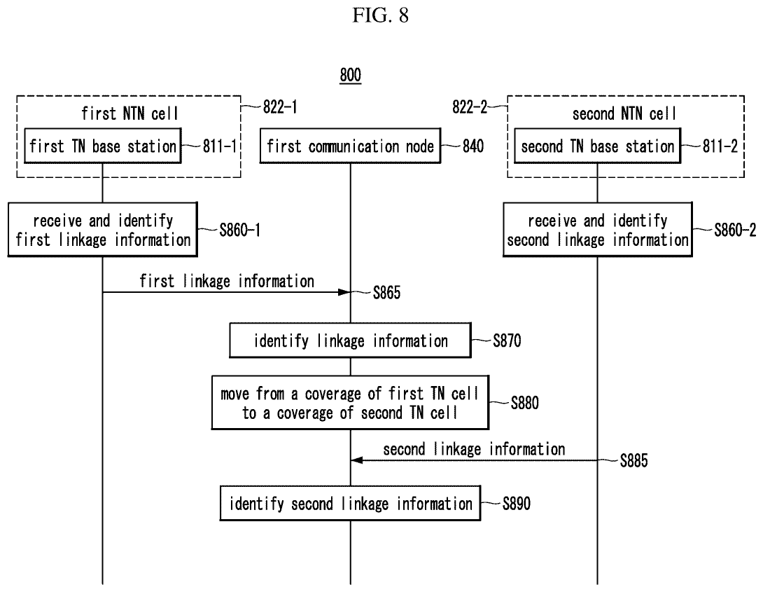

FIG. 8 is a sequence chart for describing a second exemplary embodiment of a signaling method in a communication system.

Referring to FIG. 8, a communication system may include a TN and an NTN. The TN may include one or more TN cells formed by one or more TN base stations. The NTN may include one or more NTN cells formed by one or more satellites (or UAS systems, etc.). The communication system may further include a linkage management device for managing a correspondence relationship and linkage between the TN cells and the NTN cells. Here, the linkage management device may be the same as or similar to the linkage management device 730 described with reference to FIG. 7. Hereinafter, in describing a second exemplary embodiment of a signaling method in a communication system with reference to FIG. 8, descriptions redundant with those described with reference to FIGS. 1 to 7 may be omitted.

In the communication system 800, a TN cell coverage formed by a first TN base station 811-1 may be included in or overlapped with cell coverages of one or more NTN cells. For example, a cell coverage of a first TN cell formed by the first TN base station 811-1 may be included in or overlapped with a cell coverage of a first NTN cell 822-1. In the communication system 800, a TN cell coverage formed by a second TN base station 811-2 may be included in or overlapped with cell coverages of one or more NTN cells. For example, a cell coverage of a second TN cell formed by the second TN base station 811-2 may be included in or overlapped with a cell coverage of a second NTN cell 822-2.

The first TN base station 811-1 may identify linkage information received from the linkage management device (not shown) included in the communication system 800 (S860-1). The second TN base station 811-2 may identify linkage information received from the linkage management device (not shown) included in the communication system 800 (S860-2). The linkage information that the first TN base station 811-1 and the second TN base station 811-2 receive from the linkage management device (not shown) may be the same as or similar to the linkage information described with reference to FIG. 7.

The first TN base station 811-1 and the second TN base station 811-2 may obtain information on a correspondence relationship between one or more TN cells and one or more NTN cells and/or information on linkages between the one or more TN cells and one or more NTN cells based on the received and identified linkage information. For example, the first TN base station 811-1 may obtain information on one or more NTN cells (e.g. the first NTN cell 822-1) that has a corresponding relationship with itself. The second TN base station 811-2 may obtain information on one or more NTN cells (e.g. the second NTN cell 822-2) that has a correspondence relationship with itself.

The first TN base station 811-1 may transmit linkage information including at least a part of the information obtained in step S860-1 to a first communication node 840 connected to the first TN cell formed by the first TN base station 811-1 (S865). The operation according to step S865 may be the same as or similar to the operation according to step S765 described with reference to FIG. 7. The first communication node 840 may identify the linkage information received from the first TN base station 811-1 (S870). As a result, the first communication node 840 may obtain information on one or more NTN cells (e.g. the first NTN cell 822-1) having a corresponding relationship with at least the first TN base station 811-1. As a result, the first communication node 840 may obtain information on one or more NTN cells (e.g. the first NTN cell 822-1) having a corresponding relationship with at least the first TN base station 811-1.

The first communication node 840 may perform communication with one or more NTN cells (or satellites forming one or more NTN cells) having a corresponding relationship with the first TN base station 811-1 based on the linkage information obtained in step S870. The operation of the first communication node 840 will be described in more detail below with reference to FIG. 9.

The linkage information transmitted and received in step S865 may include information on the location of the first TN base station 811-1. The information on the location of the first TN base station 811-1 may be information on an absolute location. Alternatively, the information on the location of the first TN base station 811-1 may be information on a relative location. Here, the information on the location of the first TN base station 811-1 may be, for example, information on a relative location with respect to a reference point of the first NTN cell 822-1. The first communication node 840 may identify the information on the location of the first TN base station 811-1 included in the linkage information received in step S865. The first communication node 840 may identify an absolute location of the first TN base station 811-1 based on the information on the location of the first TN base station 811-1 included in the linkage information received in step S865 (i.e. information on the relative location with respect to the reference point of the first NTN cell 822-1) and the information on the reference point of the first NTN cell 822-1. The first communication node 840 may identify its own location based on the location of the first TN base station 811-1.

The first communication node 840 may move in the communication environment and may move from a coverage of the first TN cell formed by the first TN base station 811-1 to a coverage of a second TN cell formed by a second TN base station 811-2 (S880). Accordingly, the first communication node 840 may connect to the second TN cell. In other words, the first communication node 840 may move or handover from the first TN cell to the second TN cell.

The second TN base station 811-2 may transmit linkage information including at least a part of the information obtained in step S860-2 to the first communication node 840 connected to the second TN cell formed by the second TN base station 811-2 (S885). The operation according to step S885 may be the same as or similar to the operation according to step S765 described with reference to FIG. 7. The first communication node 840 may identify the linkage information received from the second TN base station 811-2 (S890). As a result, the first communication node 840 may obtain information on one or more NTN cells (e.g. the second NTN cell (822-2)) having a corresponding relationship with at least the second TN base station 811-2.

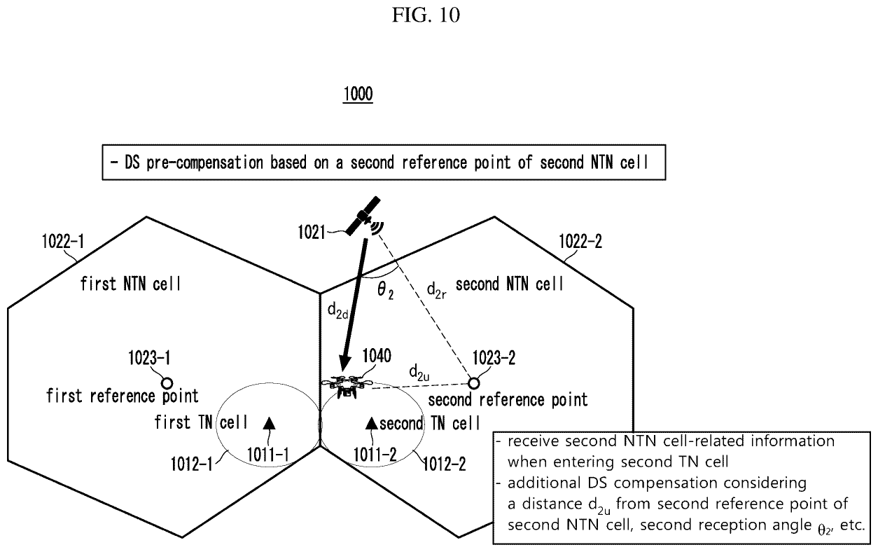

Based on the linkage information obtained in step S890, the first communication node 840 may perform communication with one or more NTN cells (or satellites forming one or more NTN cells) having a corresponding relationship with the second TN base station 811-2. The operation of the first communication node 840 will be described in more detail below with reference to FIG. 10.

The linkage information transmitted and received in step S885 may include information on the location of the second TN base station 811-2. The information on the location of the second TN base station 811-2 may be information on an absolute location. Alternatively, the information on the location of the second TN base station 811-2 may be information on a relative location. Here, the information on the location of the second TN base station 811-2 may be, for example, information on a relative location with respect to a reference point of the second NTN cell 822-2. The first communication node 840 may identify the information on the location of the second TN base station 811-2 included in the linkage information received in step S885. The first communication node 840 may identify an absolute location of the second TN base station 811-2 based on the information on the location of the second TN base station 811-2 included in the linkage information received in step S885 (i.e. information on the relative location with respect to the reference point of the second NTN cell 822-2) and the information on the reference point of the second NTN cell 822-2. The first communication node 840 may identify its own location based on the location of the second TN base station 811-2.

FIG. 9 is a conceptual diagram for describing a first exemplary embodiment of a DS compensation method in a communication system.

Referring to FIG. 9, a communication system may include a TN and an NTN. The TN may include one or more TN cells formed by one or more TN base stations. The NTN may include one or more NTN cells formed by one or more satellites (or UAS systems, etc.). The communication system may further include a linkage management device for managing a correspondence relationship and linkage between the TN cells and the NTN cells. Here, the linkage management device may be the same as or similar to the linkage management device 730 described with reference to FIG. 7. Hereinafter, in describing a first exemplary embodiment of a DS compensation method in a communication system with reference to FIG. 9, descriptions redundant with those described with reference to FIGS. 1 to 8 may be omitted.

In an exemplary embodiment of the communication system 900, a TN cell coverage formed by a first TN base station 911-1 may be included in or overlapped with cell coverages of one or more NTN cells. For example, a cell coverage of a first TN cell 912-1 formed by the first TN base station 911-1 may be included in or overlapped with a cell coverage of a first NTN cell 922-1 formed by a first satellite 921.

A first communication node 940 may perform communication with the first TN cell 912-1 (or the first TN base station 911-1 forming the first TN cell 912-1) and/or the first NTN cell 922-1 (or the first satellite 921 forming the first NTN cell 922-1) in an area where the cell coverages of the first TN cell 912-1 and the first NTN cell 922-1 overlap.

The first TN base station 911-1 may transmit linkage information including at least a part of information received from the linkage management device (not shown) included in the communication system 900, to the first communication node 940 connected to the first TN cell 912-1, in the same or similar manner as described with reference to FIG. 7 or FIG. 8. For example, the first communication node 940 may receive the linkage information from the first TN base station 911-1 (or the first TN cell 912-1) when entering the first TN cell 912-1. The first communication node 940 may obtain at least a part of information on the first TN cell 912-1, information on the first NTN cell 922-1, and information on a correspondence relationship between the first TN cell 912-1 and the first NTN cell 922-1 based on the linkage information received from the first TN base station 911-1.

For example, the first communication node 940 may obtain the location of a first reference point 923-1, which is a reference point of the first NTN cell 922-1, the location, speed, path (e.g. a passage time over a specific point), operation information, etc. of the first satellite 921, based on the linkage information received from the first TN base station 911-1. The first communication node 940 may identify information such as a distance d1u between the first communication node 940 and the first reference point 923-1, a first reception angle θ1, etc. based on the obtained information. Here, the first reception angle θ1 may refer to an angle formed by the first reference point 923-1, the first satellite 921, and the first communication node 940. The information thus identified may be utilized to perform DS compensation for a signal received by the first communication node 940 from the first NTN cell 922-1.

In order for the first communication node 940 to identify the distance d1u between the first communication node 940 and the first reference point 923-1, the first reception angle θ1, etc., the first communication node 940 may need to identify its own location. The first communication node 940 may identify its own location based on a positioning system such as a Global Positioning System (GPS) or a Global Navigation Satellite System (GNSS).

On the other hand, the first communication node 940 may identify its own location based on the first TN base station 911-1. For example, the first communication node 940 may receive information on the location of the first communication node 940 from the first TN base station 911-1. Alternatively, the first communication node 940 may receive information on the location of the first TN base station 911-1 from the first TN base station 911-1, and may also identify information on its own location based on the information on the location of the first TN base station 911-1. That is, the first communication node 940 may identify the location of the first TN base station 911-1, and may identify its own relative location with respect to the first TN base station 911-1. Through this, the first communication node 940 may identify its own location. Here, the first communication node 940 may obtain information on the location of the first TN base station 911-1 through the linkage information received from the first TN base station 911-1 or separate signaling. The information on the location of the first TN base station 911-1 may be information on an absolute location (e.g. coordinate information). Alternatively, the information on the location of the first TN base station 911-1 may be information on a relative location. Here, the information on the location of the first TN base station 911-1 may be information on a relative location with respect to the location of the first reference point 923-1, which is, for example, the reference point of the first NTN cell 922-1.

The first communication node 940 may identify the information on the location of the first TN base station 911-1 included in the linkage information received from the first TN base station 911-1. The first communication node 840 may identify the absolute location of the first TN base station 911-1 based on the information on the location of the first TN base station 911-1 included in the linkage information received from the first TN base station 911-1 (i.e. information on the relative location with respect to the location of the first reference point 923-1, which is the reference point of the first NTN cell 922-1) and the information on the location of the first reference point 923-1. The first communication node 940 may identify its own location based on the location of the first TN base station 911-1.

In an exemplary embodiment of the communication system 900, the first NTN cell 922-1 (or the first satellite 921 forming the first NTN cell 922-1) may transmit a first signal to the first communication node 940. Here, the first NTN cell 922-1 may apply DS pre-compensation to the first signal transmitted to the first communication node 940. Here, the DS pre-compensation applied to the first signal may be determined based on the location of the first reference point 923-1. Specifically, the DS pre-compensation applied to the first signal may be determined based on a distance d1r between the first reference point 923-1, which is the reference point of the first NTN cell 922-1 where the first communication node 940 is located, and the first satellite 921. To this end, the first satellite 921 may obtain or monitor information on the NTN cell and/or TN cell connected to the first communication node 940 through the first communication node 940 or the linkage management device (not shown).

The first communication node 940 may receive the first signal transmitted by the first NTN cell 922-1 with DS pre-compensation applied based on the location of the first reference point 923-1. The first communication node 940 may apply additional DS compensation based on information obtained from the linkage information received from the first TN cell 912-1 while receiving the first signal. For example, the first communication node 940 may identify information such as a distance d1u between the first communication node 940 and the first reference point 923-1, the first reception angle θ1, etc., based on the linkage information received from the first TN base station 911-1. The first communication node 940 may apply additional compensation (i.e. additional DS compensation) to the first signal to which DS pre-compensation is applied in the first NTN cell 922-1 by considering the distance d1u between the first communication node 940 and the first reference point 923-1, the first reception angle θ1, etc.

The DS pre-compensation and additional DS compensation performed in the above-described manner may be regarded as corresponding to a rough DS compensation operation and a precise DS compensation operation, respectively. Alternatively, the DS pre-compensation and additional DS compensation performed in the above-described manner may be regarded as corresponding to a common DS compensation operation and a specific DS compensation operation, respectively. Alternatively, the DS pre-compensation and additional DS compensation performed in the above-described manner may be regarded as corresponding to a coarse DS compensation operation and a fine DS compensation operation, respectively.

FIG. 10 is a conceptual diagram for describing a second exemplary embodiment of a DS compensation method in a communication system.

Referring to FIG. 10, a communication system may include a TN and an NTN. The TN may include one or more TN cells formed by one or more TN base stations. The NTN may include one or more NTN cells formed by one or more satellites (or UAS systems, etc.). The communication system may further include a linkage management device for managing the correspondence relationship and linkage between the TN cells and the NTN cells. Here, the linkage management device may be the same as or similar to the linkage management device 730 described with reference to FIG. 7. Hereinafter, in describing a second exemplary embodiment of a DS compensation method in a communication system with reference to FIG. 10, descriptions redundant with those described with reference to FIGS. 1 to 9 may be omitted.

TN cell coverages formed by a first TN base station 1011-1 and a second TN base station 1011-2 of the communication system 1000 may be included in or overlapped with cell coverages of one or more NTN cells, respectively. For example, a cell coverage of a first TN cell 1012-1 formed by the first TN base station 1011-1 may be included in or overlapped with a cell coverage of a first NTN cell 1022-1 formed by a first satellite 1021. A cell coverage of a second TN cell 1012-1 formed by a second TN base station 1011-2 may be included in or overlapped with a cell coverage of a second NTN cell 1022-2 formed by the first satellite 1021.

The first communication node 1040 may perform communication with the first TN cell 1012-1 (or the first TN base station 1011-1 forming the first TN cell 1012-1) and/or the first NTN cell 1022-1 (or the first satellite 1021 forming the first NTN cell 1022-1) in an area where the cell coverages of the first TN cell 1012-1 and the first NTN cell 1022-1 overlap. In this case, the first communication node 1040 may receive a first signal to which DS pre-compensation is applied based on a location of a first reference point 1023-1 of the first NTN cell 1022-1 within the first NTN cell 1022-1, and may apply additional DS compensation to the received first signal. This may be the same as or similar to the first exemplary embodiment of the DS compensation method described with reference to FIG. 9.

The first communication node 1040 may move in the communication environment, and may move from a coverage of the first TN cell 1012-1 to the coverage of the second TN cell 1012-2. Accordingly, the first communication node 1040 may be connected to the second TN cell 1012-2. The second TN base station 1011-2 may transmit linkage information including at least a part of information received from the linkage management device (not shown) included in the communication system 1000, to the first communication node 1040 connected to the second TN cell 1012-2, in the same manner as or similar to that described with reference to FIG. 7 or FIG. 8. For example, when the first communication node 1040 enters the second TN cell 1012-2, the first communication node 1040 may receive the linkage information from the second TN base station 1011-2 (or the second TN cell 1012-2). The first communication node 1040 may obtain at least a part of information on the second TN cell 1012-2, information on the second NTN cell 1022-2, and information on a correspondence relationship between the second TN cell 1012-2 and the second NTN cell 1022-2 based on the linkage information received from the second TN base station 1011-2.

For example, the first communication node 1040 may obtain the location of a second reference point 1023-2, which is a reference point of the second NTN cell 1022-2, the location, speed, path (e.g. passage time over a specific point), operation information, etc. of the second satellite 1021, based on the linkage information received from the second TN base station 1011-2. The first communication node 1040 may identify information such as a distance d2u between the first communication node 1040 and the second reference point 1023-2, a second reception angle θ2, etc. based on the obtained information. Here, the second reception angle θ2 may refer to an angle formed by the second reference point 1023-2, the second satellite 1021, and the first communication node 1040. The information thus identified may be utilized to perform DS compensation for a signal received by the first communication node 1040 from the second NTN cell 1022-2.

In order for the first communication node 1040 to identify the distance d2u between the first communication node 1040 and the first reference point 1023-2, the second reception angle θ2, etc., the first communication node 1040 may need to identify its own location. The first communication node 1040 may identify its own location based on a positioning system such as a GPS or GNSS.

On the other hand, the first communication node 1040 may identify its own location based on the second TN base station 1011-2. For example, the first communication node 1040 may receive information on the location of the first communication node 1040 from the second TN base station 1011-2. Alternatively, the first communication node 1040 may receive information on the location of the second TN base station 1011-2 from the second TN base station 1011-2, and may also identify information on its own location based on the information on the location of the second TN base station 1011-2. That is, the first communication node 1040 may identify the location of the second TN base station 1011-2, and may identify its own relative location with respect to the second TN base station 1011-2. Through this, the first communication node 1040 may identify its own location. Here, the first communication node 1040 may obtain information on the location of the second TN base station 1011-2 through the linkage information received from the second TN base station 1011-2 or separate signaling. The information on the location of the second TN base station 1011-2 may be information on an absolute location (e.g. coordinate information). Alternatively, the information on the location of the second TN base station 1011-2 may be information on a relative location. Here, the information on the location of the second TN base station 1011-2 may be information on a relative location with respect to the location of a second reference point 1023-2, which is, for example, a reference point of the second NTN cell 1022-2.

The first communication node 1040 may identify the information on the location of the second TN base station 1011-2 included in the linkage information received from the second TN base station 1011-2. The first communication node 840 may identify the absolute location of the second TN base station 1011-2 based on the information on the location of the second TN base station 1011-2 included in the linkage information received from the second TN base station 1011-2 (i.e. information on the relative location with respect to the location of the second reference point 1023-2, which is the reference point of the second NTN cell 1022-2), and the information on the location of the second reference point 1023-2. The first communication node 1040 may identify its own location based on the location of the second TN base station 1011-2.

In an exemplary embodiment of the communication system 1000, the second NTN cell 1022-2 (or the second satellite 1021 forming the second NTN cell 1022-2) may transmit a second signal to the first communication node 1040. Here, the second NTN cell 1022-2 may apply DS pre-compensation to the second signal transmitted to the first communication node 1040. Here, the DS pre-compensation applied to the second signal may be determined based on the location of the second reference point 1023-2. Specifically, the DS pre-compensation applied to the second signal may be determined based on a distance d2r between the second reference point 1023-2, which is the reference point of the second NTN cell 1022-2 where the first communication node 1040 is located, and the second satellite 1021. To this end, the second satellite 1021 may obtain or monitor information on the NTN cell and/or TN cell connected to the first communication node 1040 through the first communication node 1040 or the linkage management device (not shown).

The first communication node 1040 may receive the second signal transmitted by the second NTN cell 1022-2 with DS pre-compensation applied based on the location of the second reference point 1023-2. The first communication node 1040 may apply additional DS compensation based on information obtained based on the linkage information received from the second TN cell 1012-2 while receiving the second signal. For example, the first communication node 1040 may identify information such as a distance d2u between the first communication node 1040 and the second reference point 1023-2, the second reception angle θ2, etc., based on the linkage information received from the second TN base station 1011-2. The first communication node 1040 may apply additional compensation (i.e. additional DS compensation) to the second signal to which DS pre-compensation is applied in the second NTN cell 1022-2 by considering the distance d2u between the first communication node 1040 and the second reference point 1023-2, the second reception angle θ2, etc.

According to an exemplary embodiment of the method and apparatus for Doppler shift compensation in a communication system, in a communication environment where a TN and an NTN coexist, one or more TN cells can obtain linkage information including information on one or more NTN cells having coverages overlapping with its own coverage, from a linkage management device. The one or more TN cells may transmit the obtained linkage information to a first communication node (user, terminal, ground/air vehicle, etc.) connected to the one or more TN cells. The information on one or more satellites forming the one or more NTN cells can be identified. The one or more NTN cells may transmit a first signal to which DS pre-compensation is applied based on each reference point of the one or more TN cells, to the first communication node. The first communication node may apply additional DS compensation to the first signal. As a result, DS compensation can be effectively performed in the communication environment where the TN and NTN coexist.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. An operation method of a first communication node accessing a terrestrial network (TN) and a non-terrestrial network (NTN), the operation method comprising:
receiving, from a first TN cell, first linkage information including information on one or more NTN cells including at least a first NTN cell, in a coverage of the first TN cell overlapping with a coverage of the first NTN cell;
identifying information on a location of a first satellite forming the first NTN cell and information on a location of a first reference point of the first NTN cell, which are included in the first linkage information;
receiving, from the first NTN cell, a first signal to which a first Doppler shift (DS) pre-compensation is applied based on the location of the first reference point; and
applying a first additional DS compensation to the received first signal, the first additional DS compensation being based on the location of the first satellite, the location of the first reference point, and a location of the first communication node.

2. The operation method according to claim 1, wherein the first linkage information is generated based on second linkage information obtained by the first TN cell from a linkage management device connected to one or more TN cells including at least the first TN cell and the one or more NTN cells, and the second linkage information is generated based on third linkage information obtained by the linkage management device from the one or more NTN cells.

3. The operation method according to claim 1, wherein the first linkage information further includes at least one of speed information of the first satellite, path information of the first satellite, and operation information of the first satellite.

4. The operation method according to claim 1, wherein the first DS pre-compensation applied to the first signal is determined based on a distance between the first satellite and the first reference point.

5. The operation method according to claim 1, wherein the applying of the first additional DS compensation comprises:
identifying a first reception angle based on the location of the first reference point, the location of the first satellite, and the location of the first communication node;
identifying a distance between the first reference point and the first communication node based on the location of the first reference point and the location of the first communication node;
determining the first additional DS compensation based on the first reception angle and the location of the first reference point; and
applying the determined first additional DS compensation to the first signal.

6. The operation method according to claim 5, further comprising:
identifying information on a location of the first TN cell, before identifying the first reception angle; and
identifying the location of the first communication node based on the information on the location of the first TN cell.

7. The operation method according to claim 6, wherein when the first linkage information further includes information on the location of the first TN cell, the information on the location of the first TN cell is information on a relative location of the first TN cell with respect to the location of the first reference point, and the identifying of the information on the location of the first TN cell comprises identifying information on an absolute location of the first TN cell based on the information on the location of the first TN cell.

8. The operation method according to claim 1, further comprising: after the applying of the first additional DS compensation,
moving to a coverage of a second TN cell overlapping the coverage of the first NTN cell;
receiving, from the second TN cell, fourth linkage information including information on one or more NTN cells including at least the first NTN cell in the coverage of the second TN cell;
identifying information on an updated location of the first satellite and information on a location of a second reference point, which is an updated reference point of the first NTN cell, which are included in the fourth linkage information;
receiving, from the first NTN cell, a second signal to which a second DS pre-compensation is applied, the second DS pre-compensation being based on the location of the second reference point; and
applying a second additional DS compensation to the received second signal, the second additional DS compensation being based on the updated location of the first satellite, the location of the second reference point, and an updated location of the first communication node.

9. The operation method according to claim 1, further comprising: after the applying of the first additional DS compensation,
moving to a coverage of a third TN cell overlapping a coverage of a second NTN cell different from the first NTN cell;
receiving, from the third TN cell, fifth linkage information including information on one or more NTN cells including at least the second NTN cell in the coverage of the third TN cell;
identifying information on a location of a second satellite forming the second NTN cell and information on a location of a third reference point, which is a reference point of the second NTN cell, which are included in the fifth linkage information;
receiving, from the second NTN cell, a third signal to which a third DS pre-compensation is applied, the third DS pre-compensation being based on the location of the third reference point; and
applying a third additional DS compensation to the received third signal, the third additional DS compensation being based on the location of the second satellite, the location of the third reference point, and the location of the first communication node.

10. An operation method of a first terrestrial network (TN) cell in a communication system where a TN and a non-terrestrial network (NTN) coexist, the operation method comprising:
receiving first linkage information including information on one or more NTN cells from a linkage management device connected to one or more TN cells including at least the first TN cell and the one or more NTN cells;
identifying a first NTN cell corresponding to the first TN cell among the one or more NTN cells based on the first linkage information;
generating second linkage information corresponding to the first NTN cell based on the first linkage information; and
transmitting the second linkage information in downlink within a coverage of the first TN cell,
wherein the second linkage information includes information on a location of a first satellite forming the first NTN cell and information on a location of a first reference point of the first NTN cell, and the information included in the second linkage information is used to determine an additional Doppler shift (DS) compensation to be applied to a first signal to which a DS pre-compensation is applied, the first signal being transmitted from the first NTN cell and received by each of one or more communication nodes receiving the second linkage information in downlink.

11. The operation method according to claim 10, further comprising:
receiving, from the linkage management device, third linkage information including updated information on the one or more NTN cells, after transmitting the second linkage information in downlink;
generating fourth linkage information including updated information on the first NTN cell corresponding to the first TN cell based on the third linkage information; and
transmitting the fourth linkage information in downlink within the coverage of the first TN cell.

12. The operation method according to claim 10, further comprising:
receiving, from the linkage management device, fifth linkage information including updated information on the one or more NTN cells, after transmitting the second linkage information in downlink;
identifying a second NTN cell corresponding to the first TN cell and different from the first NTN cell among the one or more NTN cells based on the fifth linkage information;
generating sixth linkage information corresponding to the second NTN cell based on the fifth linkage information; and
transmitting the sixth linkage information in downlink within the coverage of the first TN cell.

13. The operation method according to claim 10, further comprising: transmitting seventh linkage information to the linkage management device, wherein the seventh linkage information includes at least one of information on the first TN cell and information on one or more communication nodes connected to the first TN cell.

14. The operation method according to claim 10, wherein the second linkage information further includes information on the location of the first TN cell, and the information on the location of the first TN cell is used by each of one or more communication nodes receiving the second linkage information in downlink to identify a location of the each of one or more communication nodes.

15. The operation method according to claim 14, wherein the information on the location of the first TN cell is information on a relative location of the first TN cell with respect to the location of the first reference point, and an absolute location of the first TN cell is identified based on the information on the location of the first TN cell and the information on the location of the first reference point.

16. An operation method of a linkage management device in a communication system where a terrestrial network (TN) and a non-terrestrial network (NTN) coexist, the operation method comprising:
receiving first linkage information on one or more NTN cells from the one or more NTN cells connected to the linkage management device;
identifying information on a first NTN cell corresponding to a first TN cell among the one or more NTN cells based on the first linkage information;
generating second linkage information corresponding to the first NTN cell based on the first linkage information; and
transmitting the second linkage information to the first TN cell,
wherein the second linkage information includes information on a location of a first satellite forming the first NTN cell and information on a location of a first reference point of the first NTN cell, and the information included in the second linkage information is used to determine an additional Doppler shift (DS) compensation to be applied to a first signal to which a DS pre-compensation is applied, the first signal being transmitted from the first NTN cell and received by each of one or more communication nodes within a coverage of the first TN cell.

17. The operation method according to claim 16, further comprising:
receiving, from the one or more NTN cells, third linkage information including updated information on the one or more NTN cells, after transmitting the second linkage information;
generating fourth linkage information including updated information on the first NTN cell corresponding to the first TN cell based on the third linkage information; and
transmitting the fourth linkage information to the first TN cell.

18. The operation method according to claim 16, further comprising:
receiving fifth linkage information including updated information on the one or more NTN cells, after transmitting the second linkage information;
identifying a second NTN cell corresponding to the first TN cell and different from the first NTN cell among the one or more NTN cells based on the fifth linkage information;
generating sixth linkage information corresponding to the second NTN cell based on the fifth linkage information; and
transmitting the sixth linkage information to the first TN cell.

19. The operation method according to claim 16, further comprising: receiving seventh linkage information from the first TN cell, wherein the seventh linkage information includes at least one of information on the first TN cell and information on one or more communication nodes connected to the first TN cell.
